(19) United States
(12) Patent Application Publication
(10) Pub. No.: US 2012/0146539 A1
(43) Pub. Date: Jun. 14, 2012

(54) JITTER DETECTION AND COMPENSATION CIRCUIT FOR LED LAMPS

(76) Inventor: Scott Arthur Riesebosch, St. Catharines (CA)

(21) Appl. No.: 12/965,407

(22) Filed: Dec. 10, 2010

(51) Int. Cl. H05B 37/02

(52) U.S. Cl. 315/291

(57) ABSTRACT

A power signal driving an LED is measured to determine a characteristic (e.g., a power level) of the power signal. The characteristic is compared to the power signal's history and any deviation is detected. If the source of the deviation is determined to be jitter, the deviation is compensated for.

### TECHNICAL FIELD

Embodiments of the invention generally relate to LED lamps and, in particular, to improving the quality of light emitted from an LED lamp and the lamp's responsiveness to user input.

### BACKGROUND

The popularity of LED-based lighting systems, also known as LED lamps, as replacements for traditional light sources continues to grow. One of the many challenges in designing replacement LED lamps is making them behave like the light sources they are replacing, despite their underlying differences; users may be reluctant to use an LED lamp if the light it provides is significantly different from, for example, light from an incandescent bulb. LED lamps tend to react more quickly to changes in input voltage because LEDs have a faster response time than, say, a filament in an incandescent bulb. This fast response time can be a detriment in LED lamps when, for example, they are exposed to noisy power supplies; small deviations in power signal strength or rise/fall times (i.e., “jitter”), to which traditional light sources are too slow to react, may produce visible flicker in LED lamps.

It may be possible to reduce this flicker, with some success, by filtering the power signal before it reaches the LED. The stronger the filter, the more the deviations are eliminated or delayed. One problem with such a filter, however, is that it necessarily applies to any deviations in the power supply signal, no matter their source. In some cases, most notably through the use of a dimmer switch, a user may intend to vary (i.e., introduce deviations in) the power supply to an LED in order to dim or brighten it. The filter, intended to remove undesirable deviations that could lead to flickering of the LED, also works against changes intentionally introduced by the dimmer. The user operating the dimmer will notice a delay between a change in the dimmer setting and a resulting change in the brightness of the light.

Thus, there is a fundamental conflict between a deviation-reducing filter and a dimmer: making the filter too strong will negatively impact the use of the dimmer, but making the filter too weak, while allowing the dimmer to be more responsive to user input, will permit the LED to flicker in response to jitter. A need therefore exists for a way to reconcile this conflict.

### SUMMARY

In general, various aspects of the systems and methods described herein identify the source of a deviation in an LED power supply signal and take action appropriate thereto. If the deviation is caused by a dimmer, the deviation is applied to the LED unchanged. If, on the other hand, the deviation is caused by jitter, it is wholly or partially filtered or otherwise removed from the power supply signal using any suitable technique, examples of which are described herein. In one embodiment, history information of the power signal is stored, and a current power pulse is compared to the saved history information to determine the source of the deviation. Jitter may be filtered by applying extra energy to a non-light-emitting load or by cutting off a jittering edge of the power signal.

Accordingly, in one aspect, a system detects and selectively compensates for deviations in a power signal driving an LED. A circuit detects a deviation in the power signal, and determines a cause of the deviation. Circuitry selectively compensates for the deviation based at least in part on the determined cause.

In various embodiments, the circuitry for selectively compensating for the deviation includes a filter for filtering the power signal and/or circuitry for modifying a behavior of an LED driver circuit in accordance with the determined cause. The LED driver may include a phase-cut circuit. A storage device may store history information related to a characteristic of the power signal, and the circuit for detecting the deviation in the power signal may compare the deviation to the history information.

The deviation may include an increased power level of the power signal, and an output may apply the increased power level to a non-light-emitting load. The deviation may include a shift in timing of the power signal, and the cause of the deviation may be a dimmer circuit. In this embodiment, the power signal may not be modified. A magnetic or an electronic transformer may receive an AC mains voltage, and a regulator may supply power to the LED. A non-light-emitting load may receive a portion of the power signal.

In general, in another aspect, a method detects and selectively compensates for deviations in a power signal driving an LED. The method includes detecting a deviation in the power signal, determining a cause of the deviation, and selectively compensating for the deviation based at least in part on the determined cause.

In various embodiments, history information is stored related to the power signal; determining the cause of the deviation may include comparing the deviation to the history information. Detecting the deviation may include measuring a power level of the power signal; selectively compensating for the deviation may include applying an increased power level to a non-light-emitting load. Detecting the deviation may include measuring timing of the power signal, and selectively compensating for the deviation may include cutting a jittering portion of the power signal. The cause of the detected deviation may be a dimmer circuit; selectively compensating for the deviation may include applying the power signal unmodified to the LED. The characteristic, deviation, and/or cause may be stored in a storage device.

In general, in another aspect, a circuit for detecting and selectively compensating for deviations in a power signal driving an LED includes a detection circuit for measuring a characteristic of the power signal. A storage device stores history information of the power signal related to the characteristic, and an analysis engine determines a cause of a detected deviation in the characteristic relative to the history information. Circuitry selectively compensates for the deviation based at least in part on the determined cause. In another aspect, a method for detecting and compensating for deviations in a power signal driving an LED includes measuring a characteristic of the power signal, detecting a deviation between the characteristic and history information of the power signal related to the characteristic, determining a cause of a detected deviation, and selectively compensating for the deviation based at least in part on the determined cause.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and may exist in various combinations and permutations.

### BRIEF DESCRIPTION OF THE DRAWINGS

In the drawings, like reference characters generally refer to the same parts throughout the different views. In the following description, various embodiments of the present invention are described with reference to the following drawings, in which:

FIG. 1 is a block diagram of a circuit for distinguishing between jitter and a dimmer-induced change in a power level in accordance with an embodiment of the invention;

FIG. 2 is a block diagram of a jitter analyzer in accordance with an embodiment of the invention;

FIG. 3 is a chart illustrating a series of dimmed and undimmed waveforms in accordance with an embodiment of the invention; and

FIG. 4 is a flowchart illustrating a method for distinguishing between jitter and a dimmer-induced change in a power level in accordance with an embodiment of the invention.

### DETAILED DESCRIPTION

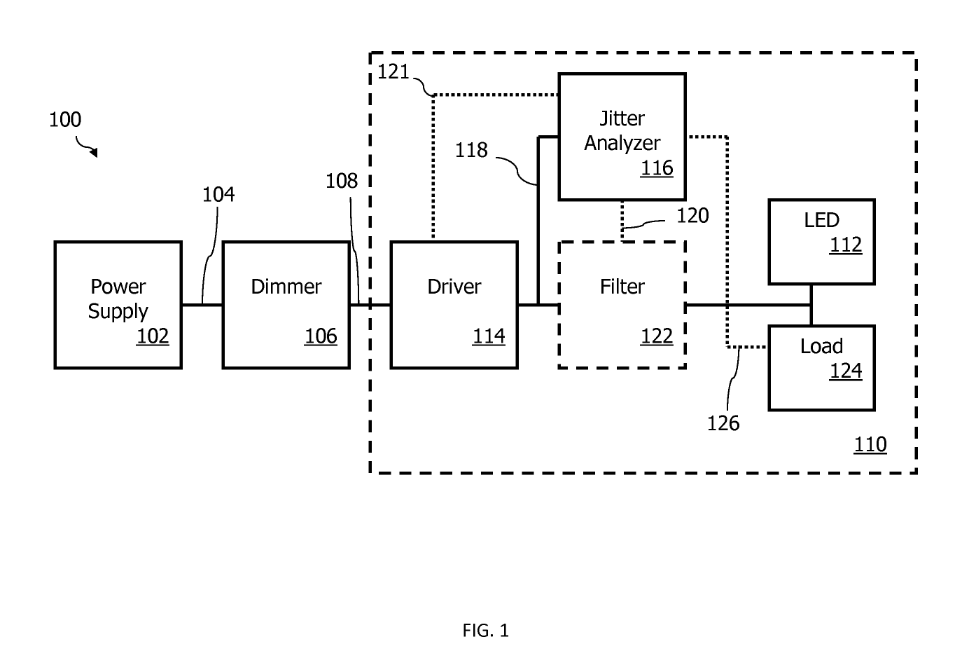

Described herein are various embodiments of methods and systems for analyzing a deviation in a power signal driving an LED and determining a source of the deviation. If the source of the deviation is a dimmer switch, the power signal is applied to the LED unchanged; if, on the other hand, the source is jitter (or other unwelcome noise), the power signal is filtered or modified before it is applied to the LED. FIG. 1 illustrates one embodiment of an LED lighting system 100 that includes circuitry for detecting and selectively removing such noise. A power supply 102, for example an AC mains supply, provides an AC input signal 104. A dimmer 106 may be used to alter a power level of the AC input signal 104 and provide a dimmed AC signal 108. An LED lighting module (also known as an LED lamp) 110 receives the dimmed AC signal 108 and alters it into a form suitable to drive an LED 112.

The LED lamp 110 includes a driver 114 that converts the dimmed AC signal 108 into a form suitable for driving the LED 112. In one embodiment, the driver 114 includes a transformer for changing the magnitude, frequency, and/or polarity of the dimmed AC signal 108. The transformer may be a magnetic, electronic, or any other type of transformer. The driver 114 may further include a regulator that receives the transformed input signal and provides a current- or voltage-regulated output signal for driving the LED 112. Other components and features, such as a DC-to-DC converter or ballast, may be included in the driver 114; the current invention is not limited to any particular type of driver circuit. Furthermore, the arrangement of the components in the system 100 is not intended to be limiting, and other arrangements and combinations are within the scope of the invention. For example, the dimmer 106 may not be present, or may be incorporated into the LED lamp 110. The driver 114 may not include a transformer, which may be disposed outside the LED lamp 110, on the opposite side of the dimmer 106 (i.e., proximate or incorporated within the power supply 102), or may not be present at all.

A jitter analyzer 116 detects deviations in an LED power supply signal 118. As shown in FIG. 1, the monitored power signal 118 is an output of the driver 114; in other embodiments, the jitter analyzer monitors a power signal closer to the LED 112 (to better estimate noise observed by the LED 112) or closer to the power supply 102 (which may be a more convenient or less costly observation point). In general, a deviation in the LED power signal 118 is any change to the signal that produces an observable change in brightness in the LED 112. The deviation may be an increase or decrease in the magnitude, pulse width, frequency, or other characteristic of the LED power supply signal. The jitter analyzer 116 determines whether any observed deviations are a result of jitter (or other noise) or the result of an adjustment to the dimmer 106 and acts accordingly, as described in more detail below.

The deviations in the power signal 118, as one of skill in the art will understand, may come from any number of sources. The voltage produced by the power supply 102 may fluctuate if, for example, another load proximate the LED lamp 110 is suddenly switched on or off. Nearby electrical systems may emit electromagnetic radiation that may couple to, and induce noise in, any of the components or wiring depicted in FIG. 1. Those components themselves may produce noise due to, for example, manufacturing defects and component mismatches. In one embodiment, the dimmer 106 and/or the transformer in the driver 114 engage or “fire” at less-than-ideal times (i.e., sooner or later than intended) and thereby introduce noise into the power supply signal. For example, the dimmer 106 may be a leading-edge dimmer, meaning that it chops off a beginning portion of the power supply signal in each cycle and allows a remaining portion to pass unchanged. The threshold point between the chopped portion and the remaining portion may occur at, for example, 1 ms into each 8.33 ms half-cycle of a 60 Hz input waveform; due to any or all of the above noise sources, however, this 1 ms threshold may fluctuate by, for example, ±100 μs from 0.9 ms to 1.1 ms. This fluctuation may be severe enough to cause the LED 112 to noticeably flicker.

The jitter analyzer 116 analyzes the type and magnitude of any deviations in the power signal 118. In one embodiment, the jitter analyzer 116 includes a storage device for storing deviation history. The storage device may be any storage medium known in the art, such as flash memory, standard RAM, solid-state memory, or any other kind of volatile or non-volatile memory. In one embodiment, a nonvolatile storage device is used to retain history information when the LED lamp 110 is powered off; in another embodiment, the storage device includes volatile memory and new history information is collected each time the LED lamp 110 is powered on.

The deviation history may include information for cycles or half-cycles of the power signal 118, such as the number of cycles analyzed, how long ago a cycle occurred, the time of a cycle's leading edge, the power transmitted by the cycle, the peak voltage of a cycle, and/or the time of a cycle's falling edge. To obtain this information, the jitter analyzer 116 may analyze one or more cycles and, for each analyzed cycle, take a plurality of samples of the voltage of the power signal 118 during the cycle. To select the cycles to be analyzed, the jitter analyzer 116 may look at saved history information from prior cycles; if changes are detected cycle-by-cycle, more cycles may be selected for analysis, and fewer if not. In other embodiments, the jitter analyzer 116 may analyze a fixed subset of cycles (e.g., every fifth, tenth, or twentieth cycle) or every cycle. Cycles may be analyzed more frequently when the LED lamp 110 is initially powered on, especially if the storage device includes volatile memory and no prior history information is saved.

Once a cycle is selected for analysis, the power signal 118 is examined during the cycle to determine its characteristics. For example, digital samples of the power signal 118 may be taken at an appropriate sampling rate (e.g., 0.1, 1, or 10 kHz), and the voltage level at each time point may be recorded (in either the storage device or in a temporary buffer). Once the cycle is complete, the samples for that cycle may be analyzed. The highest voltage level recorded may be saved as the cycle's peak voltage, the time of a sample-by-sample increase in voltage may be saved as the time of the cycle's rising edge, and the time of a sample-by-sample decrease in voltage may be saved as the time of the cycle's falling edge. In one embodiment, the rising and falling edge times are recorded as they occur instead of at the end of the cycle.

The sampling rate may be fixed or may vary in response to characteristics of the power signal 118. For example, if no deviations are observed for a given number (e.g., 10) cycles in a row, the jitter analyzer 116 may increase the sampling rate to provide finer granularity in the measurements. In another embodiment, if no deviations are observed, the jitter analyzer 116 reduces the sampling rate.

Once a current cycle of the power signal 118 has been sampled and its maximum voltage, power, and rise/fall times have been determined, it is compared to previous cycles. One or more algorithms may be used determine if any deviations in the power signal 118 are the result of jitter or a change in a setting of the dimmer 106. For example, the magnitude of a deviation in maximum voltage may be compared to a threshold; if the magnitude is less than the threshold, then the source of the deviation is determined to be jitter, and if greater, the dimmer 106. The threshold may be based on a maximum amount of expected jitter and/or a minimum amount of dimmer change. The maximum expected jitter may be computed based on component tolerances, amount of coupled noise expected, and/or amount of fluctuation allowed in the power supply 102. The minimum amount of dimmer change may be based on physical limitations of the dimmer 106; e.g., the dimmer 106 may be set using a rotatable knob or slide that is mechanically limited in terms of adjustment precision. In various embodiments, the threshold may be a cycle-by-cycle change in maximum voltage of 0.1, 0.5, 1, 2, or 5%. In other embodiments, the threshold may be learned by observing the behavior of prior cycles. For example, if the maximum voltage increases or decreases consistently across a number of cycles (e.g., 10 cycles), the source of the change in maximum voltage is assumed to be the dimmer 106. In this case, the amount of change in the maximum voltage per cycle is stored as the threshold. Similarly, if the maximum voltage bounces back and forth between two values for a number of cycles (e.g., 10 cycles), the source of the change is assumed to be jitter, and the amount of the change (i.e., the difference between or average of the two maximum values) is stored as the threshold. If more than one threshold is derived (e.g., from both detected jitter and from detected dimmer action), the thresholds may be averaged together to create a single threshold.

The rise and/or fall times of the power signal 118 may be similarly analyzed to determine if the source of any deviations is jitter or the dimmer 106. Like the deviations in the maximum voltage per cycle, deviations in the rise and/or fall times caused by the dimmer 106 may be assumed to be larger in magnitude and/or consistent across several cycles. Deviations caused by jitter, on the other hand, may be assumed to be smaller in magnitude and/or vary between relatively fixed values across cycles. For example, deviations of less than approximately 100 μs per cycle may be assumed to be from jitter, and deviations greater than 100 μs per cycle may be assumed to be caused by the dimmer 106. In other embodiments, jitter in the rise and/or fall times in the power signal 118 may be predictable—especially jitter caused by the early or late firing of the dimmer 106 or transformer in the driver 114—and the jitter analyzer 116 may learn and account for this jitter. For example, the jitter analyzer 116 may observe the rise and/or fall time changing between two values for several consecutive cycles and, as a result, identify the cause of the changes as jitter (regardless of the magnitude of the changes). Once identified, this jitter may be normalized out of the analyzed power signal 118, so that only changes above and beyond the identified jitter are considered. In one embodiment, the jitter analyzer tracks the amount of detected jitter as a function of dimmer position—when fully engaged, for example, the dimmer 106 may introduce more jitter than when it is fully disengaged.

In one embodiment, the jitter analyzer 116 reaches a conclusion about the source of a deviation in the power signal 118 that is later proved wrong. For example, the jitter analyzer 116 may identify a deviation in a current cycle as jitter but, by observing that the deviation continues to grow or decrease consistently across later cycles, recognize that the real source of the deviation was the dimmer 106, and that the initial determination as jitter was incorrect. In this case, the jitter analyzer 116 may adjust any learned thresholds or values to ensure that a similar deviation occurring in the future is properly identified. This self-learning behavior through ongoing analysis of deviation patters is readily programmed, without undue experimentation, based on the principles outlined herein. In another embodiment, if the jitter analyzer 116 cannot make a conclusive determination given data from a single cycle, it collects information across one or more additional cycles before making a determination.

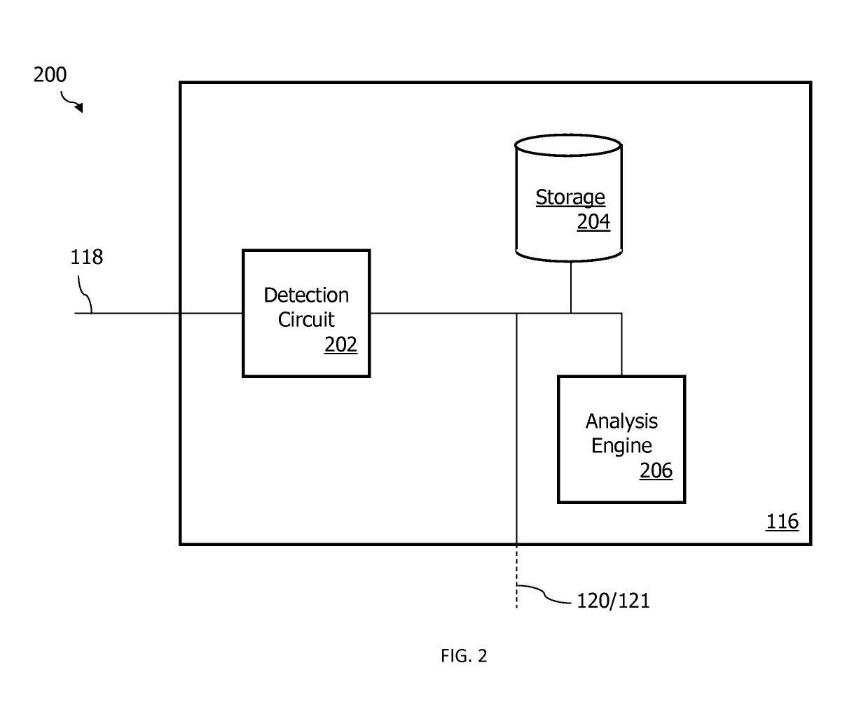

A block diagram of one embodiment 200 of the jitter analyzer 116 is shown in FIG. 2. A detection circuit 202 receives the power signal 118 and measures a characteristic thereof. For example, as described above, the detection circuit may select a cycle of the power signal 118 and determine its power, maximum voltage, rise/fall times, or any other characteristic relevant to measuring cycle-by-cycle deviations in the power signal 118. As described above, the detection circuit 202 may digitally sample the power signal 118 or, in another embodiment, determines the characteristics using analog components. Some or all of the sampled data and/or the determined characteristics are stored in a storage device 204 and analyzed by an analysis engine 206. The analysis engine 206 may include a processor, microprocessor, application-specific integrated circuit, field-programmable grid array, or any other type of digital logic circuit programmed to implement the analysis functions described above. The program may be written in any of a number of high-level languages, such as FORTRAN, PASCAL, C, C++, C#, Java, Tcl, or BASIC. Further, the program can be written in a script, macro, or functionality embedded in commercially available software, such as EXCEL or VISUAL BASIC. Additionally, the software may be implemented in an assembly language directed to a microprocessor resident on a computer. For example, the software can be implemented in Intel 80×86 assembly language if it is configured to run on an IBM PC or PC clone. The software may be embedded on an article of manufacture including, but not limited to, computer-readable program means such as a floppy disk, a hard disk, an optical disk, a magnetic tape, a PROM, an EPROM, or CD-ROM.

Once the analysis engine 206 reaches a determination about the source of a deviation in a current cycle, it outputs a control signal 120 to the filter 122 and/or a control signal 121 to the driver 114. As one of skill in the art will understand, the current invention is not limited to the particular configuration shown in FIG. 2, and the detection circuit 202, storage device 204, and analysis engine 206 may be implemented as one component or subdivided into additional components.

If the analysis engine 206 detects a deviation and its source is determined to be the dimmer 106, in one embodiment, the jitter analyzer 116 configures or operates (e.g., disengages) the filter 122 to allow the deviation to pass through to the LED 112 unchanged (or with only minimal changes). If a deviation is detected and its source is jitter, the jitter detector 116 may configure the filter 122 to wholly or partially remove the jitter from the power signal 118, as described in more detail below. If no deviation is detected, the filter may be left engaged or disengaged. The filter 122 may be a simple low-pass filter that is selectively engaged by the control signal 120. In other embodiments, the filter 122 may be more sophisticated, such as a multi-tap filter having coefficients programmable by the jitter analyzer 116.

In another embodiment, the jitter analyzer 116 configures or modifies the driver 114 to reduce or remove the jitter. For example, the timing of a signal output by the driver 114 may be advanced or delayed to compensate for timing-induced jitter. In another embodiment, an amplification of the power signal 118 by the driver 114 may be modified (i.e., increased or decreased) to offset the effects of jitter.

In one embodiment, if a jitter-induced increase in the power in the power signal 118 is detected, the jitter analyzer 116 may engage a non-light-emitting load 124 via a control signal 126 to absorb the increase. The non-light-emitting load 126 may be a variable resistor, and the jitter analyzer 116 may control the magnitude of the load 124 in accordance with the magnitude of the jitter-induced increase in power. Thus, the LED 112 is not exposed to a change in power despite the jitter.

In one embodiment, if there is no jitter in the power level, the non-light-emitting load 124 is disengaged; in this embodiment, the non-light-emitting load 124 is engaged only when a jitter-induced increase in power is observed by the jitter analyzer 116. In another embodiment, the non-light-emitting load 124 is partially engaged even when no jitter is observed. In this embodiment, the non-light-emitting load 124 may be used to react to both increases and decreases in power caused by jitter. If a jitter-induced decrease in power is observed, the resistance of the non-light-emitting load 124 is lowered, thereby transferring power to the LED 112 to make up for the power shortfall caused by the jitter. The nominal resistance of the non-light-emitting load 124 may be dynamically altered by the jitter analyzer 116 in accordance with jitter observed in the power signal 118; if frequent positive and negative jitter values are observed, the nominal jitter analyzer 116 my set the resistance of the non-light-emitting load 124 may be set to a nonzero value to account for them. If less-frequent jitter is observed, however, the nominal resistance may be returned to zero to conserve power.

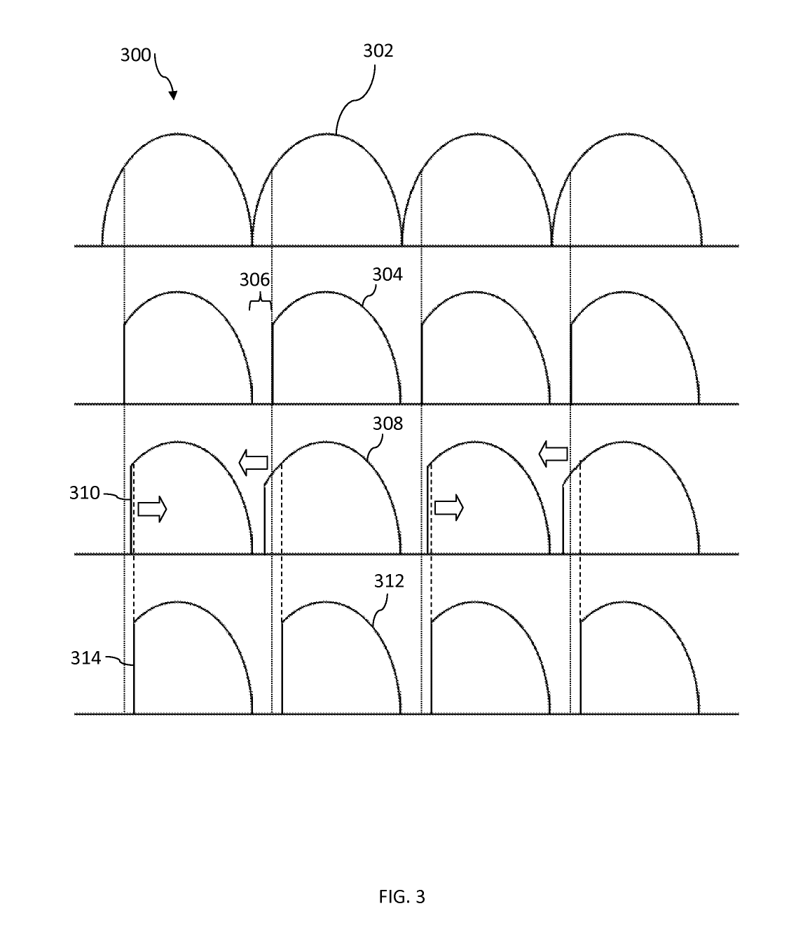

In another embodiment, if jitter is detected in a rising edge or a falling edge of the power signal 118, the jitter analyzer 116 may operate the filter 122 and/or driver 114 to cut out the jittering portion of the signal to produce a jitter-free signal. FIG. 3 illustrates a series of waveforms 300 that illustrate the principle behind this phase-cut function of the filter 122 and/or driver 114. A first signal 302 represents an ideal, un-dimmed half-wave rectified signal. Note that, while the first signal 302 and the rest of the waveforms in FIG. 3 depict the 60 Hz output of a magnetic transformer, the principles described herein may be applied to a higher-frequency output of an electronic transformer. A second signal 304 represents an output of an ideal leading-edge dimmer, in which precisely the same amount 306 is removed from the beginning of each cycle. The third signal 308 shows, however, the output of a real dimmer, in which the leading edge 310 jitters back and forth. In this example, the leading edge 310 arrives late in the first and third cycles and early in the second and fourth cycles. The discrepancy in the leading-edge arrival time of consecutive cycles may cause enough cycle-by-cycle power variation to cause the LED 112 to flicker.

The fourth signal 312 is phase-cut to remove the jittering portion of the third signal 308. By setting the time of a new leading edge 314 to be later than the latest leading edge detected in the third signal 308, the pulses in the fourth signal 312 are all of equal size and power. Therefore, delivering the pulses in the fourth signal 312 to the LED 112 results in flicker-free operation. The phase-cut filter, as described herein, operates on a leading-edge dimmer, but may be applied to a trailing-edge dimmer equally well. In each case, the jitter analyzer 116 may track the jitter-induced back-and-forth arrival times of the leading and/or trailing edges of the power signal 118, compute an amount of the phase to cut, and send that value to the filter 122 and/or driver 114 via the control signal 120 or 121.

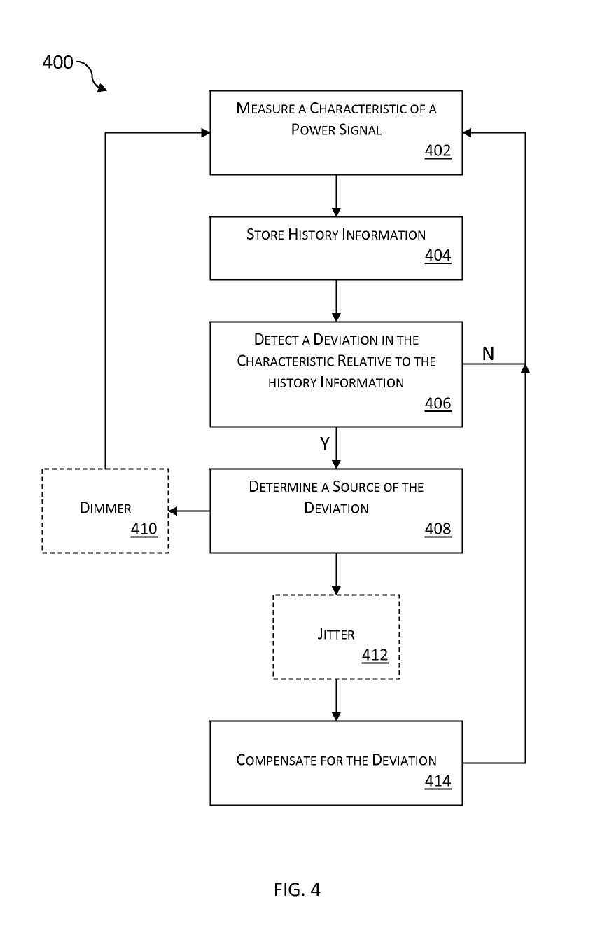

The jitter-reduction, filter, and/or driver circuits described above may be operated in accordance with the flowchart depicted in FIG. 4. In a first step 402, a characteristic of a power signal (such as the power signal 118) is measured. As described above, the characteristic may be a power level, a maximum voltage, and/or rise/fall times of the signal. In a second step 402, history information related to the measurements may be stored (e.g., in a storage device). In a third step 406, the measurements may be compared to previously taken measurements, and any deviation in the current measurements is detected. If no deviation is detected, the method returns to the first step 402 and takes a new measurement on a new cycle of the power signal. If a deviation is detected, in a fourth step 408, the source of the deviation is determined, in accordance with the methods and algorithms described above. If the source is a dimmer (Step 410), the deviations are applied to the LED and the method returns to the first step 402. If the source is jitter (Step 412), the deviations are compensated for (via one or more of the methods described above), and the method returns to the first step 402.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A system for detecting and selectively compensating for deviations in a power signal driving an LED, the system comprising:
a circuit for detecting a deviation in the power signal and determining a cause of the deviation;
circuitry for selectively compensating for the deviation based at least in part on the determined cause.

2. The system of claim 1, wherein the circuitry for selectively compensating for the deviation comprises a filter for filtering the power signal in accordance with the determined cause.

3. The system of claim 1, wherein the circuitry for selectively compensating for the deviation comprises circuitry for modifying a behavior of an LED driver circuit in accordance with the determined cause.

4. The system of claim 3, wherein the LED driver comprises a phase-cut circuit.

5. The system of claim 1, further comprising a storage device for storing history information related to a characteristic of the power signal.

6. The system of claim 5, wherein the circuit for detecting the deviation engine compares the deviation to the history information.

7. The system of claim 1, wherein the deviation comprises an increased power level of the power signal.

8. The system of claim 7, further comprising an output for applying the increased power level to a non-light-emitting load.

9. The system of claim 1, wherein the deviation comprises a shift in timing of the power signal.

10. The system of claim 1, wherein the cause of the deviation is a dimmer circuit.

11. The system of claim 10, wherein the circuitry for selectively compensating for the deviation engine does not modify the power signal.

12. The system of claim 1, further comprising one of a magnetic or an electronic transformer for receiving an AC mains voltage.

13. The system of claim 1, further comprising a regulator for supplying power to the LED.

14. The system of claim 1, further comprising a non-light-emitting load for receiving a portion of the power signal.

15. A method for detecting and selectively compensating for deviations in a power signal driving an LED, the method comprising:
detecting a deviation in the power signal;
determining a cause of the deviation; and
selectively compensating for the deviation based at least in part on the determined cause.

16. The method of claim 15, further comprising storing history information related to the power signal.

17. The method of claim 16, wherein determining the cause of the deviation comprises comparing the deviation to the history information.

18. The method of claim 15, wherein detecting the deviation comprises measuring a power level of the power signal.

19. The method of claim 18, wherein selectively compensating for the deviation comprises applying an increased power level to a non-light-emitting load.

20. The method of claim 15, wherein detecting the deviation comprises measuring timing of the power signal.

21. The method of claim 20, wherein selectively compensating for the deviation comprises cutting a jittering portion of the power signal.

22. The method of claim 15, wherein the cause of the detected deviation is a dimmer circuit.

23. The method of claim 22, wherein selectively compensating for the deviation comprises applying the power signal unmodified to the LED.

24. The method of claim 15, further comprising storing one of the characteristic, deviation, or cause in a storage device.

25. A circuit for detecting and selectively compensating for deviations in a power signal driving an LED, the circuit comprising:
a detection circuit for measuring a characteristic of the power signal;
a storage device for storing history information of the power signal related to the characteristic;
an analysis engine for determining a cause of a detected deviation in the characteristic relative to the history information; and
circuitry for selectively compensating for the deviation based at least in part on the determined cause.

26. A method for detecting and compensating for deviations in a power signal driving an LED, the method comprising:
measuring a characteristic of the power signal;
detecting a deviation between the characteristic and history information of the power signal related to the characteristic;
determining a cause of a detected deviation; and
selectively compensating for the deviation based at least in part on the determined cause.
